(19) United States
(12) Patent Application Publication
(10) Pub. No.: US 2012/0246047 A1
(43) Pub. Date: Sep. 27, 2012

(54) No Preset Spending Limit Analysis System and Method

(76) Inventors: Nikki Waters, Foster City, CA (US); Amy Alterman, Foster City, CA (US); Laurence Poirier, Foster City, CA (US); Stan Myers, San Mateo, CA (US); Bruce Twedt, San Mateo, CA (US)

(21) Appl. No.: 13/243,372

(22) Filed: Sep. 23, 2011

Related U.S. Application Data
(60) Provisional application No. 61/385,814, filed on Sep. 23, 2010.

(51) Int. Cl. G06Q 40/00

(52) U.S. Cl. 705/35

(57) ABSTRACT

Embodiments of the invention relates to a methodology consisting of using active account management to segment a portfolio with internal behavior score bands and a number of key performance metrics. In one potential embodiment, a server computer receives a set of data for NPSL accounts and identifies a risk for each account in the plurality of accounts. Accounts may then be grouped, and adjustments made in an ongoing basis to groups of accounts within the portfolio based on updated risk and use status.

### BACKGROUND

For many businesses and consumers, high dollar items may account for a large percentage of total spending. To pay for high dollar items, small businesses have, in the past, use more traditional payment methods such as checks. In many situations, however, these businesses and consumers can have irregular revenue cycles and often need a line of credit available on a business credit card or other payment token that will enable spending on high dollar items even when the need for spending is occurs out of time with revenue.

Many conventional business credit cards do not permit transactions beyond pre-defined spending limits. New consumers are usually assigned a low initial credit limit. The credit limit may be is slowly increased over time as the consumer's tenure increases and based on payment behavior. The need for higher credit at the start up of a business is usually not a key factor in determining the initial credit limit. Consequently, conventional business credit cards may not have the spend bandwidth required to allow new businesses to purchase high dollar items often needed at or around start up. In some cases, transactions may be declined at the point of sale (POS), without notification or direct contact with the consumer.

Some conventional systems offer credit cards with no preset spending limit for business consumers. While these services are currently offered, current systems are structured where providers receive a limited amount of transaction data, and cannot perform an optimal risk analysis, the issuer/acquirer that uses the closed network bears a substantial risk when allowing a business consumer to use a card with a no preset spending limit. This lack of information may cause additional risk for the service provider if the system is not managed appropriately. Additionally, current systems and methods for setting revolve limits and “pads” that may exceed a revolve limit in an no preset spending limit account are not standardized, do not make use of all the available relevant data, and do not respond to changes in information quickly.

### BRIEF SUMMARY

Various non-limiting embodiments of the invention are described below. Certain embodiments are directed to improved financial account management systems, apparatuses, and methods, particularly in relation to accounts with no preset spending limit (NPSL).

Certain embodiments of the invention are directed to a method and system for using active account management to segment a portfolio with internal behavior score bands (e.g., FICO) and a number of key performance indicators and metrics.

One potential implementation includes a method of setting a characteristic for an NPSL (no pre-set spending limit) account. According to such an implementation, a system electronically receives a set of data for a plurality of NPSL accounts at a server computer via a communication link. The system identifies, using the server computer, at least one performance metric for each account in the plurality of accounts. The system may then identify, using the server computer, a use status for each account of the plurality of accounts as a transactor, a revolver, or an inactive status. After this, the system electronically groups the plurality of NPSL accounts by at least one performance metric and the use status of each account to create a plurality of account groups and electronically analyzes each group of the plurality of account groups using the server computer. The system may then proceed by adjusting, using the server computer, the characteristic for the NPSL account by electronically adjusting the characteristic for each account in a first group of the plurality of account groups by an amount determined by the analyzing of each group of the plurality of account groups.

In additional alternative embodiments, the method may also include electronically analyzing each group of the plurality of groups comprising electronically determining a key performance index for each of the account groups using the server computer.

In additional alternative embodiments, the method may also include using the server computer where the characteristic for the NPSL account further comprises electronically determining a risk associated with the NPSL account using the key performance index; electronically determining a change in risk associated with a change in the characteristic; and adjusting the characteristic based on the electronically determined change in risk.

In additional alternative embodiments, the performance metric comprises a cycle balance total for the account, the characteristic for the NPSL account is an authorization pad amount, or the characteristic for the NPSL account is an interest rate for the NPSL account.

In additional alternative embodiments, the set of data is a data feed received at the server computer from an issuer or the performance metric comprises an expected loss rate.

Methods according to aspects of the present innovations may also include the steps of receiving, at the server computer, a set of baseline data for the plurality of NPSL account prior to the receiving of the set of data; electronically analyzing the set of baseline data to determine data required for no pre-set spending limit analysis; and communicating, from the server computer to an issuer, a request for the set of data for the plurality of NPSL accounts. These steps may still further include receiving a second set of data at the server computer; electronically analyzing the second set of data to identify additional accounts not associated with the plurality of NPSL accounts; electronically grouping the additional accounts with the plurality of NPSL accounts by the at least one performance metric and the use status of the additional accounts to incorporate the additional accounts into the plurality of account groups; and electronically analyzing each group of the plurality of account groups including the additional accounts using the server computer.

Aspects of the present innovations may further be implemented as a server computer or multiple server computers comprising a processor; an interface for a communication link; and an data storage device communicatively coupled to the processor and the interface, the data storage device storing therein instructions readable by the processor for performing a method of setting and managing a characteristic of an NPSL account. In various embodiments, the method of setting and managing the characteristic of the NPSL account may comprise electronically receiving a set of data for a plurality of NPSL accounts at the server computer via the communication link; identifying, using the processor, at least one performance metric for each account in the plurality of accounts; identifying, using the processor, a use status for each account of the plurality of accounts as a transactor, a revolver, or an inactive status; and electronically grouping the plurality of NPSL accounts by the at least one performance metric and the use status of each account to create a plurality of account groups and electronically analyzing each group of the plurality of account groups using the processor.

In various server computer based systems, the server(s) the method may further comprise adjusting, using the processor, the characteristic for the NPSL account by electronically adjusting the characteristic for each account in a first group of the plurality of account groups by an amount determined by the analyzing of each group of the plurality of account groups. The method may also further comprise electronically determining a risk associated with the NPSL account using the key performance index; electronically determining a change in risk associated with a change in the characteristic; or communicating the risk and the change in risk to an issuer computer associated with the NPSL account.

In additional alternative server computer based embodiments, electronically analyzing each group of the plurality of groups comprises electronically determining a key performance index for each of the account groups using the server computer; the performance metric may comprise an issuer internal risk score; or the key performance index may comprise an average charge off rate.

These and other embodiments are described in further detail below.

### BRIEF DESCRIPTION OF THE DRAWINGS

FIG. 1 illustrates a flowchart of a method according to an embodiment of the invention.

FIG. 2 illustrates a block diagram of a system according to an embodiment of the invention.

FIG. 3 illustrates a flowchart of a method according to an embodiment of the invention.

FIG. 4 illustrates a block diagram of a system according to an embodiment of the invention.

FIG. 5 illustrates a flowchart of a method according to an embodiment of the invention.

FIG. 6 illustrates an exemplary computer system, in which various embodiments may be implemented.

FIG. 7 illustrates a flowchart of a method according to an embodiment of the invention.

### DETAILED DESCRIPTION

Embodiments of the invention disclosed herein are directed to improved financial account management systems, apparatuses, and methods. More specifically, embodiments of the invention disclosed herein include systems and methods for analyzing and managing portfolios of accounts that include accounts having no preset spending limit (NPSL).

No preset spending limit is a card feature that extends the spending capacity of a cardholder beyond the revolve limit. The revolve limit is the balance amount identified as acceptable for an account to maintain over payment periods. Any balance amount over the revolve limit which is authorized may be referred to as the pad or the authorization pad.

In one potential embodiment transaction data, user data, and any other relevant data for accounts in a portfolio having NPSL accounts is identified. The accounts are divided up into a plurality of segments based on various characteristics associated with each account. Key performance indicators are calculated for each portfolio segment, and based on the indicators, adjustments are made to account characteristics for accounts within each portfolio segment. Account characteristics that may be adjusted include values such as credit limits, interest rates, default authorization pads, or marketing rewards.

No preset spending limit is a card feature that may be required or optional for accounts within a portfolio. The extension of the spending capacity may be based on the cardholder's profile and behavior history, or may be set as a result of the analysis of key performance indicators described above. Unlike a traditional credit product with a pre-set spending limit, a credit product with no preset spending limit targets higher income and higher spend segments.

Various embodiment of the present innovations provide benefits not known in the current field by analyzing portfolios of accounts and portfolio segments rather than individual NPSL accounts, and also by using sets of targeted metrics or key performance indexes. These embodiments thus function to ensure positive cardholder experience and minimum disruption at the point-of-sale in a way not known in the current field. This is further done while at the same time minimizing risk where the magnitude of the risk may be higher than in a traditional account due to the lack of a preset spending limit. A no preset spending limit product cannot be effectively managed by using the revolve limit and the maximum authorization limit to control the account balance. Instead, an issuer may use all available information to make decisions away from the point-of-sale, and novel techniques are required to more effectively manage risk in NPSL portfolios. Embodiments of the invention address the problem of managing the NPSL feature to drive cardholder engagement and portfolio revenue by minimizing risk, point-of-sale declines, and other problems using novel data analysis and risk feedback for portfolios.

In various embodiments either of these innovations may be implemented separately or together, so that portfolio analysis and the use of metrics and indexes may be electronically implemented by a server computer to manage single accounts and portfolios of accounts electronically with improved technical performance. Thus, certain embodiments of the invention may provide one or more technical advantages to a number of entities. Such entities may include issuers, merchants, and consumers.

A technical advantage to an issuer is that providing cards (or other payment tokens) with improved electronic NPSLs analysis by a server computer may expand the penetration of cards into business spend categories and may capture transactions typically conducted using more traditional and potentially less efficient and effective payment methods. Another technical advantage to a merchant is that increased speed of adjustment in NPSL pad amounts by a system or method including improved electronic NPSL analysis may limit a category of losses that occurs when the circumstances of an individual user or group of users changes such that certain authorizations become more or less risky. Electronic NPSL analysis according to embodiments of the present invention provide the technical benefit of improved customer service and risk analysis is responding to changes in incoming data patterns.

A technical advantage of improved electronic NPSL analysis may enable broader consumer access to NPSL accounts providing a technical advantage to a consumer having a small business by allowing small businesses to purchase high dollar items such as raw material and rent, which are currently constrained by low pre-set spending limits associated with conventional cards. Another technical advantage to a consumer is that the exposure limit will not be dependent on the consumer's tenure. Since the consumer acquisition process can be stringent, initial exposure limits can be generous and can be based on the needs of the consumer. Another technical advantage to a consumer is that risk assessment is based on transactions on cards from more than one issuer. Another technical advantage is the ability of improved electronic NPSL analysis to identify and provide responsive service to identifiable periodic large purchases, for example annual international travel, and to modify NPSL account characteristics in response to such identified periodic expenditures.

A technical advantage to a merchant is that providing cards with an NPSL to consumers results in increased revenue to the merchant. An additional technical advantage from electronic NPSL analysis is improved speed at the point of sale associated with purchases that exceed a customer's revolve limit.

Certain embodiments of the invention may include none, some, or all of the above technical advantages. One or more other technical advantages may be readily apparent to one skilled in the art from the figures, descriptions, and claims included herein.

The following definitions are presented to clarify components or aspects of various embodiments of the innovations presented herein, and are used in conjunction with one or more of the figures described below.

“Revolve limit” as described herein refers to a maximum balance that an account may roll from one period to another. Typically, interest is charged on this amount. Both accounts within a portfolio that have no preset spending limit and accounts that have a preset spending limit will have a set revolve limit. For accounts with a preset spending limit, an attempt to purchase an amount or create an owed balance greater than the revolve limit will typically result in a transaction being declined and/or a punitive fee.

“Authorization pad” or “pad” as described herein refers to a set amount greater than the revolve limit. The authorization pad used by a user typically must be paid off before the end of the period, which is typically a billing period to avoid punitive action.

“No preset spending limit,” as described above, is a characteristic of an account where the maximum spending limit, which is the sum of the revolve limit and the authorization pad, is not a preset amount. Instead, the amount may be determined at the time of the transaction, or may vary over time in a way that may attempt to provide the user with an experience as if they have no limit while maintaining acceptable business risk levels.

“Risk” as described herein refers to an expected likelihood or probability associated with a current or future event. In one potential embodiment, risk refers to a likelihood that an accrued balance on an account will not be repaid, and will have to be written off. In another potential embodiment, risk refers to a likelihood that current transaction is fraudulent, or being presented by a person or device not authorized to engage in the transaction. In an alternative embodiment, risk may refer to a probability that a credit account will receive payment in the future for an amount advanced as part of a currently occurring transaction. In a further alternative embodiment, risk may refer to a possibility that a transaction will result in a charge-back where an amount paid to a merchant must be returned from the merchant to a user account.

“Key performance indicators” or KPIs, as described herein, are calculated values that may be used to assess risks or opportunities for an account or set of accounts. A KPI may be based solely on data from a transaction, issuer, or user that directly describes an account or user. KPIs may also be based on statistics of such data describing a portfolio of accounts or a section of a portfolio. Alternately a KPI may be based only on other KPIs or combinations of direct data and KPIs.

A “performance metric” or “metric” may be any value, variable or other type of parameter which is used to assess performance against previous performance or a standard. For example this may be done to benchmark revenues and profits or to quantify risk. Metric, as used herein, is a more generic term than KPI, and may encompass both KPIs and direct data where a performance assessment is made.

A “user” can be an individual or organization such as a business that is capable of purchasing goods or services or making any suitable payment transaction with a merchant. In some embodiments, a user may further be referred to as a cardholder or account holder, and can refer to a consumer who has an account with an issuer that can be used to conduct transactions with merchants. A cardholder may have one or more portable consumer devices associated with the account, such as a credit card, debit card, mobile phone, etc., that can assist in the use of the account to conduct a transaction.

A “portable consumer device” can be any suitable device that can be used to conduct a payment transaction with a merchant. A portable consumer device may be in any suitable form. For example, suitable portable consumer devices can be hand-held and compact so that they can fit into a consumer's wallet and/or pocket (e.g., pocket-sized). They may include smart cards, magnetic stripe cards, keychain devices, and others. Other examples of portable consumer devices include cellular phones, personal digital assistants (PDAs), pagers, payment cards, security cards, access cards, smart media, transponders, and the like. In some cases, portable consumer device may be associated with an account of a user such as a bank account.

A “merchant” can offer goods or services to a user. A merchant may use any suitable method to conduct a payment transaction with the user. For example, a merchant may use an e-commerce business to allow the payment transaction to be conducted by a merchant and a user through the Internet. Other examples of merchants include a department store, a gas station, a drug store, a grocery store, or other suitable business. In some embodiments, a merchant may operate a merchant server that is a computing device as described below. A merchant server can be used to provide an online storefront for consumers to shop and also to conduct online transactions with consumers once the consumers have decided to purchase goods from the merchant.

An “acquirer” can be any suitable entity that has an account with a merchant and that processes merchant transactions associated with merchant access device. For example, an acquirer may be a bank.

An “issuer” can be any suitable entity that may open and maintain an account associated with a user. For example, an issuer may be a bank, a business entity such as a retail store, or a governmental entity that issues a payment account to a user. In some embodiments, an issuer may also be the acquirer in a given transaction. An issuer may also issue portable consumer devices that are associated with an issued account. Additionally, in some embodiments an issuer may create or group accounts into portfolios or sections of portfolios, and may store data related to users and transaction data for a portfolio.

A “payment processing network” such as payment processing network (PPN) can be a network of suitable entities that have information related to the account associated with a user and issued by an issuer. This Information includes profile information and other suitable information that may be used to complete a transaction between a user and a merchant involving an account.

Payment processing network may include data processing subsystems, networks, and operations used to support and deliver authorization services, exception file services, and clearing and settlement services. An exemplary payment processing network may include VisaNet™. Networks that include VisaNet™ are able to process credit card transactions, debit card transactions, and other types of commercial transactions. VisaNet™, in particular, includes an integrated payments system (Integrated Payments system) which processes authorization requests and a Base II system which performs clearing and settlement services. Payment processing networks may use any suitable wired or wireless network, including the Internet. Payment processing network may further include components such as an access control server, which can be a server computer that provides issuers, or other entities with the ability to authenticate consumers during an online transaction.

In some embodiments, the payment processing networks may include a directory server that can refer to a server computer that can be used to route messages containing enrolment and authentication information between a merchant plug-in or an access control server. The directory server can also determine whether a consumer can utilize the authentication services and can apply business rules to modify the response to a merchant plug in. In some embodiments, the directory server can be operated by a service organization such as Visa. Alternatively, the above discussed portions of payment processing networks may be created as part of alternative networks coupled to payment processing network. Further embodiments may have various combinations or multiple copies of the above network elements, or may not include all of the above network elements.

An embodiment of the invention consists of a methodology to analyze the data from the issuer to improve active account management by segmenting the portfolio by internal behavior score bands (e.g., FICO) and a number of key performance metrics to identify areas of risks and opportunities. These key performance metrics may include, but are not limited to, active accounts, household income, average credit loss rate, revolving rate, utilization, APR but also cash advance, balance transfer, remittance, authorization declines, etc. This analysis methodology allows the service to provide consulting support on handling accounts exhibiting rapid balance build, account management recommendations for accounts where the consumer exceeds the revolve limit and enters the authorization pad, cash advance and balance transfer considerations, and level setting recommendations.

Various non-limiting embodiments and methodologies consistent with the innovations presented herein are discussed below.

### I. NPSL Analysis

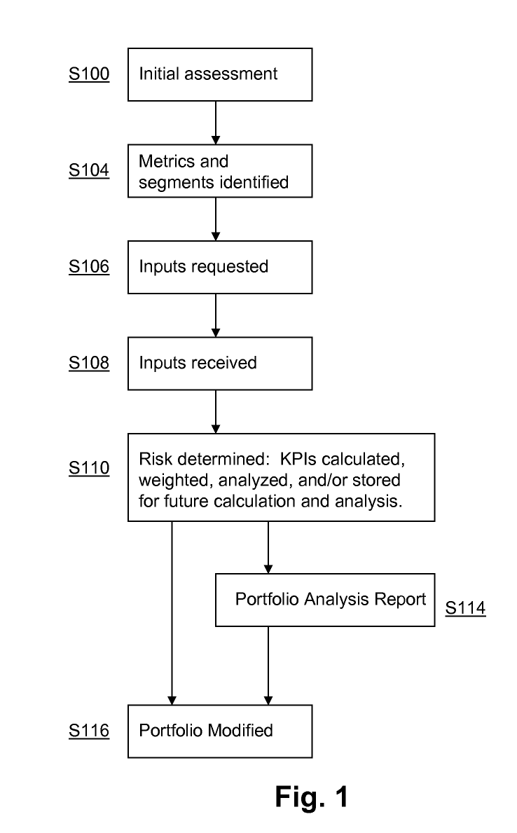

FIG. 1 describes a method of analyzing a portfolio including accounts having no preset spending limit, and includes steps S100 through S116. In certain embodiments, a subscription based service may implement NPSL analysis, or alternative embodiments may be based on an analysis made internally within an organization. NPSL analysis may be based on other objectives, such as maximizing transaction fees, or minimizing principle write-offs.

Step S100 is an initial assessment of the portfolio. Such an assessment may include initial data gathering to identify an initial state of the portfolio. This may include any historical default and profitability data, and any other historical data. This may additionally include data describing users that is not directly related to transaction data that will be gathered on an ongoing basis as the NPSL portfolio is assessed over multiple billing periods such as credit rating data. Examples of potential input data are shown in Table 1.

TABLE 1

| Data/ | | |
|---|---|---|
| Stat | Data/Statistic | |
| # | Name | Definition |
| 1 | Internal Risk Score | The risk score interval—based upon the |
| | | financial institution's internal risk score. |
| | | Actual score intervals will be determined |
| | | after consultation with financial |
| | | institutions. |
| 2 | Expected Loss | Projected Net Credit Loss Rate (% of |
| | Rate | receivables) over a 12 month period for |
| | | the Risk Score Interval (Statistic 1.) |
| 3 | Accounts Total | The number of NPSL credit card |
| | | accounts. Includes all consumer credit |
| | | card current, delinquent, and securitized |
| | | accounts, including closed accounts with |
| | | a balance. Excludes material Commercial |
| | | card, Check/Debit card, Private Label, |
| | | charged-off, and closed zero-balance |
| | | accounts. Accounts that are opened to |
| | | replace accounts closed for fraud |
| | | reasons are excluded, i.e., the closing of |
| | | one account and the opening of a |
| | | replacement account are counted as one |
| | | account. |
| 4 | Active Accounts | Number of NPSL credit card accounts |
| | (Cardholder Sent | with either of the following (2) items: 1) at |
| | Statement is Proxy | least 1 debit transaction (purchase, cash |
| | For Active) | advance, balance transfer, fee, finance |
| | | charge), 2) balance greater than 0. |
| | | Includes delinquent accounts. Excludes |
| | | accounts statemented for zero and credit |
| | | balance, payment receipt |
| | | acknowledgement, notification-only, and |
| | | charge-off. |
| 5 | Active Accounts | The number of active accounts (defined |
| | Current | in Statistic 4) with cycle end status = |
| | | Current |
| 6 | Accounts (Open or | The number of accounts (defined in |
| | Closed) Current | Statistic 3) with cycle end status = |
| | | Current |
| 7 | Accounts (Open or | The number of accounts (defined in |
| | Closed) 30+ dpd | Statistic 3) with cycle end status = 1-29 |
| | | days past due. |
| 14 | Cycle Balance | The sum of all cycle end balances for |
| | Total (CYCLE | total accounts. Sum all cycles ending in |
| | END) | a calendar month. |
| 15 | Cycle Balance - | The sum of all cycle end balances for |
| | Active Accounts | active accounts. |
| 16 | Cycle Balance - | The sum of all cycle end balances for |
| | Active Accounts | active accounts. |
| | Current | |
| 17 | Cycle Balance | The sum of all cycle end balances for |
| | Current | current accounts. |
| 18 | Cycle Balance 30+ | The sum of all cycle end balances for |
| | dpd | active accounts 30+ dpd. |
| 19 | Sum of Revolve | The sum of the revolve limits for total |
| | Limit Total (not | accounts. |
| | including PAD) | |
| 20 | Sum of Revolve | The sum of the revolve limits for total |
| | Limit Active | accounts. |
| | Accounts | |
| 21 | Sum of Revolve | The sum of the revolve limits for total |
| | Limit Active | accounts. |
| | Accounts Current | |
| 22 | Sum of Revolve | The sum of the revolve limits for total |
| | Limits of Accounts | accounts. |
| | (Open or Closed) | |
| | Current | |
| 23 | Sum of Revolve | The sum of the revolve limits for total |
| | Limits of Accounts | accounts. |
| | (Open or Closed) | |
| | 30+ dpd | |
| 24 | Cash Advance | The sum of the cash advance limits for |
| | Allowance for Total | total accounts (defined in Statistic 3.) |
| | Accounts | This is a dollar value. For example, if an |
| | | account has a $10,000 revolve limit and a |
| | | cash limit of 50%, the value for this |
| | | statistic is $5,000. |
| 25 | Authorization Pad | At cycle end, the amount above the |
| | Amount Total (Pad | revolve limit that a customer may spend. |
| | above revolve limit) | Total accounts (defined in Statistic 3.) |
| | | This is a dollar amount. For example, if |
| | | an account has a $10,000 revolve limit |
| | | and a pad value of 20%, the value for this |
| | | statistic is $2,000. |
| 26 | Authorization Pad | At cycle end, the amount above the |
| | Amount Active | revolve limit that a customer may spend. |
| | Accounts | |
| 27 | Authorization Pad | At cycle end, the amount above the |
| | Amount Active | revolve limit that a customer may spend. |
| | Accounts Current | |
| 28 | Authorization Pad | At cycle end, the amount above the |
| | Amount of | revolve limit that a customer may spend. |
| | Accounts (Open or | |
| | Closed) Current | |
| 29 | Authorization Pad | At cycle end, the amount above the |
| | Amount of | revolve limit that a customer may spend. |
| | Accounts (Open or | |
| | Closed) 1-29 dpd | |
| 30 | Authorization Pad | At cycle end, the amount above the |
| | Amount of | revolve limit that a customer may spend. |
| | Accounts (Open or | |
| | Closed) 30+ dpd | |
| 31 | Accounts with | The number of active accounts (defined |
| | Finance Charge | in Statistic 4) with the cycle end finance |
| | Total | charge greater than 0. |
| 32 | Accounts with | The number of current active accounts |
| | Finance Charge | (defined in Statistic 5) with the cycle end |
| | Active & Current | finance charge greater than 0. |
| | Status | |
| 33 | Accounts Without | The number of active accounts (defined |
| | Finance Charge | in Statistic 4) with the cycle end finance |
| | Total | charge = 0 or less. |
| 34 | Accounts Without | The number of current active accounts |
| | Finance Charge | (defined in Statistic 5) with the cycle end |
| | Active & Current | finance = 0 or less. |
| | Status | |
| 35 | Balances Subject | The sum of all cycle end balances for |
| | to Finance Charge | Accounts with Finance Charge Total. |
| | Total (Cycle End) | |
| 36 | Balances Subject | The sum of all cycle end balances for |
| | to Finance Charge | Accounts with Finance Charge Active & |
| | Active & Current | Current Status. |
| | Status (Cycle End) | |
| 37 | Balances Without | The sum of all cycle end balances for |
| | Finance Charge | Accounts without Finance Charge Total. |
| | Total | |
| 38 | Balances Without | The sum of all cycle end balances for |
| | Finance Charge | Accounts without Finance Charge Active |
| | Active & Current | & Current Status. |
| | Status (Cycle End) | |
| 39 | Number of | Number of Total Transactions approved. |
| | Transactions | |
| | Approved | |
| 40 | Number of | Number of Total Transactions declined. |
| | Transactions | |
| | Declined | |
| 41 | Number of | Number of Transactions Declined due |
| | Transactions | fraud-related reasons. |
| | Declined Due To | |
| | Fraud Status | |
| 42 | Number of | Number of Transactions Declined due for |
| | Transactions | risk-related (NOT fraud) reasons when |
| | Declined Due To | the account was delinquent AND the |
| | Both Delinquent | balance was greater than the revolve limit |
| | AND Over- | at the time of the decline. |
| | Revolve-Limit | |
| | Status | |
| 43 | Number of | Number of Transactions Declined due for |
| | Transactions | risk-related (NOT fraud) reasons when |
| | Declined Due To | the account balance was greater than the |
| | Over-Revolve-Limit | revolve limit at the time of the decline. |
| | Status | |
| 44 | Number of | Number of Transactions Declined due for |
| | Transactions | risk-related (NOT fraud) reasons when |
| | Declined Due To | the account was delinquent at the time of |
| | Delinquent Status | the decline. |
| 45 | Number of | Number of Transactions Declined due for |
| | Transactions | reasons other than Statistics 41-44. |
| | Declined Due To | |
| | Other Reasons | |
| 46 | Total Amount of | The dollar value of Total Transactions. |
| | Transactions | Net of credit values. |
| 47 | Amount of | The dollar value of Total Transactions |
| | Transactions | Approved. Net of credit values. |
| | Approved | |
| 48 | Amount of | The dollar value of Total Transactions |
| | Transactions | Declined. |
| | Declined | |
| 49 | Total Approved | The dollar value of approved sales |
| | Retail Dollars | transactions, net of approved sales credit |
| | | transactions. Exclude cash-related |
| | | transactions |
| 50 | Total Declined | The dollar value of declined sales |
| | Retail Dollars | transactions. Exclude cash-related |
| | | transactions. |
| 51 | Approved BT/ | The number of approved cash |
| | ACH/Access | disbursement transactions related to |
| | Check Cash | convenience checks and balance |
| | Transactions | transfers (electronic or by check). |
| 52 | Declined BT/ACH/ | The number of declined cash |
| | Access Check | disbursement transactions related to |
| | Cash Transactions | convenience checks and balance |
| | | transfers (electronic or by check). |
| 53 | Approved BT/ | The dollar value of approved cash |
| | ACH/Access | disbursement transactions related to |
| | Check Cash | convenience checks and balance |
| | Dollars | transfers (electronic or by check). |
| 54 | Declined BT/ACH/ | The dollar value of declined cash |
| | Access Check | disbursement transactions related to |
| | Cash Dollars | convenience checks and balance |
| | | transfers (electronic or by check). |
| 55 | Approved Other | The number of approved cash |
| | Cash Transactions | disbursement transactions NOT related to |
| | | convenience checks and balance |
| | | transfers (electronic or by check). |
| 56 | Declined Other | The number of declined cash |
| | Cash Transactions | disbursement transactions NOT related to |
| | | convenience checks and balance |
| | | transfers (electronic or by check). |
| 57 | Approved Other | The dollar value of approved cash |
| | Cash Dollars | disbursement transactions. NOT related |
| | | to convenience checks and balance |
| | | transfers (electronic or by check). |
| 58 | Gross Balance | Actual account balance (dollars) for |
| | Written-off | accounts charging off. Includes principal |
| | (Contractual + | amount + unpaid fees + unpaid finance |
| | Bankruptcy) | charges. |
| 59 | Principal Balance | Principal balance for charged-off |
| | Written-Off | accounts. Excludes unpaid fees and |
| | | unpaid finance charges. |
| 60 | Accounts Written- | Number of accounts charged-off for |
| | Off | contractual nonpayment and/or |
| | | bankruptcy. Excludes accounts charged- |
| | | off for fraud. |
| 61 | Sum of Revolve | Sum of revolve limits for Accounts Written |
| | Limits of Accounts | Off. |
| | Written Off | |

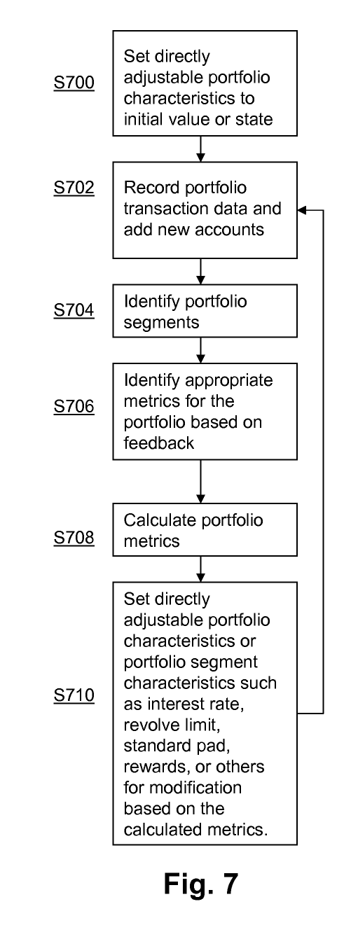

Step S100 may additionally identify initial values for control inputs or values that are directly adjustable portfolio characteristics. These are the values that may be set directly by an account issuer, such as interest rates, fees, revolve limits, pads, and rewards. Though some limits may be placed on these values by regulation, such as notification limits for changes in interest rates, all of these values may be controlled to at least some extent by the issuer and modified to achieve various results. The following steps may be influenced by an initial desired result, and results from an NPSL analysis system will typically involve a change to a directly adjustable portfolio characteristic to achieve a desired result. The controllable values and their relation to risk and revenue may be developed over time through feedback in the NPSL analysis over many payment cycles, as is described further below and in FIG. 7. Step S100 may be performed by a server computer, as described below, which is an independent server computer dedicated to electronically analyzing NPSL data and managing NPSL account, and is geographically removed from an issuer, acquirer, or merchant server computer that originates the NPSL data that is electronically analyzed. Alternatively, in certain embodiments, step S100 may be part of another system such as a payment processing network that is capable of performing thousands or millions of transaction analysis computations in seconds as part of both NPSL analysis and payment processing or account management.

In step S104, initial performance metrics are identified for evaluating a portfolio and providing feedback on portfolio performance. The portfolio may then be divided into segments based on the initial data. For example, in one embodiment, a portfolio may be divided based on an identified user status describing how a user typically deals with balance on the account. Users which pay the entire balance of the account or a sufficiently large percentage of the account balance or spending limit each month may be considered transactors. Users which pay only a portion of the entire balance each month and who typically pay interest on a balance on a regular basis may be considered revolvers. Finally, users who rarely use the account may be considered inactive. Alternatively, the segments may be based on any metric disclosed herein.

Further, in step S104, portfolio segments may be based on more than one metric. The total number of segments may be any number such that a useful portfolio segment is identified for providing account management. In one exemplary embodiment, a metric identifying a default risk is combined with a use status to create portfolio segments. In various alternative embodiments, segments may be created during or after any cycle of KPI analysis and calculation, or may be modified and updated at any point in the analysis.

In step S106, input data is requested to allow the analysis system to assess portfolio segments on an ongoing basis. The requested inputs may be limited to data specifically required to calculated a limited set of metrics for use in portfolio analysis, or may be a fixed set of generic data from which the metrics may be calculated.

Following receipt of the input data in S108, risk or any other requested performance metric may be determined in step S110. This determination in step S110 comprises calculation of key performance indicators from the input data received in step S108. Examples of key performance indicators are shown in Table 2.

TABLE 2

| KPI # | KPI/Metric | Description |
|---|---|---|
| 1 | % of Active Current | Percentage of active |
| | Accounts Revolving | accounts with current status |
| | | revolving |
| 2 | Portfolio | Percentage distribution of |
| | Composition | accounts by Transactor/ |
| | | Revolver/Inactive |
| 3 | Cash Advance | Dollar cash advance volume |
| | Volume per Active | per active account |
| | Account | |
| 4 | Cash Transactions | Number of cash transactions |
| | per Active Account | per active account |
| 5 | Delinquency Rate | Delinquent as % of total |
| 6 | Average Balance | Average Balance 30+ DPD |
| | 30+ DPD Accounts | Accounts |
| 7 | Charge-Off Rate | Charge-off dollars as % of |
| | | total balances |
| 8 | Account Charge-Off | Account charge-offs as % of |
| | Rate | Total Accounts |
| 9 | Charge-Off Balance - | Charge-off dollars per |
| | Gross | account charged-off |
| 10 | Charge-Off | Charge-off dollars as % of |
| | Utilization | charge-off revolve limits |
| 11 | Average Balance - | Dollar balance per account |
| | Current & Active | for current & active accounts |
| | Accounts | |
| 12 | Average Balance - | Average Balance - 30+ DPD |
| | 30+ DPD Accounts | Accounts |
| 13 | Revolve Limit | Revolve limit utilization for |
| | Utilization - Current | current active accounts |
| | Active Accounts | |
| 14 | Revolve Limit | Revolve limit utilization for |
| | Utilization - 30+ | 30+ dpd accounts |
| | DPD Accounts | |
| 15 | Transaction Approval | Authorization transaction |
| | Rate | approval rate |
| 16 | Dollar Approval Rate | Authorization dollar approval |
| | | rate |

The following provides additional details related to certain implementations and methods of calculating or deriving values for the key performance indicators in table 2. In various embodiments, alternative sets of initial data may be used to arrive at similar or identical KPIs. In further embodiments, additional statistics and input data are used to calculate additional KPIs not listed in tables 1 or 2.

In table 2 above, the fourth column provides a relationship between the listed key performance indicator and the data types in table 1. For example, as detailed for the first KPI, the percentage of active current account revolving (KPI #1) may be calculated by dividing the accounts with finance charge active and current by the sum of the accounts with finance charge active and current and the accounts without finance charge total.

In addition to calculation of KPIs, additional weighting or analysis steps may be performed, or additionally certain data may be stored for analysis in conjunction with data and KPIs from other transaction period.

In step S114, a portfolio analysis report may be prepared detailing metrics which were determined initially in step S104, or at any other point in the analysis process. Finally, in step S116, adjustments may be made to the directly adjustable portfolio characteristics based on the KPIs or metrics observed in the portfolio analysis report.

The process will then typically repeat during a certain period, such as every billing cycle, every business quarter, or annually. As the analysis repeats, the metrics may be updated and compared with previous results, and the effectiveness of various changes in portfolio characteristics observed. For example, results attributable to certain rewards programs may be measure, either alone or in conjunction with NPSL account functioning. In certain embodiments, accounts with preset spending limits may be analyzed, and the users offered a conversion of the account to an NPSL account based on the user's account falling within a certain portfolio segment.

### II. Subscription Based NPSL Analysis

In one embodiment of the invention, a subscription-based service can help financial institutions implement and manage NPSL effectively without putting in place additional resources. The service can be designed to help issuers implement, manage, and optimize the NPSL feature to drive cardholder engagement and portfolio revenue by minimizing risk and point-of-sale declines.

An objective of the service may be to assess authorization pad (the cardholder's spending capacity above the revolve limit) structure for the active account base that has an NPSL product. The service may focus on how accounts are managed with balances below the revolve limit (pre-pad) and the policies and practices in the management of accounts once they have exceeded the revolve limit and are within the authorization pad.

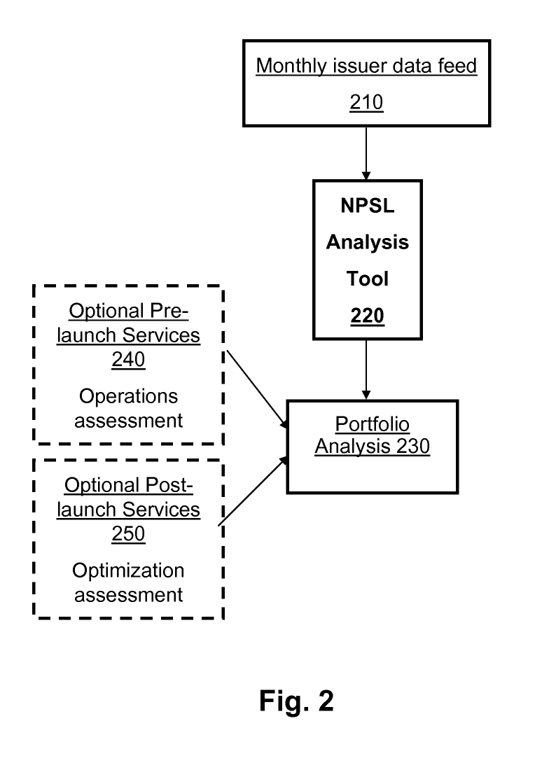

FIG. 2 illustrates a block diagram of the service methodology in accordance with an embodiment of the invention. The service requires issuers to provide a monthly data feed and, after NPSL analysis has been completed, in return the issuers receive a portfolio analysis report. This portfolio analysis report may include overall portfolio health, problem and opportunity segments, recommendations for line adjustments in new and existing accounts, authorization pad assessments for new and existing accounts, structure of authorization pads, market specific (to that country) NPSL benchmarks, etc. In addition, issuers may receive some consulting support (e.g., pre-launch operations assessment, post-launch optimization assessment) to address the gaps and opportunities identified in the report.

In alternative embodiments, the subscription service described may function as a feedback system within an issuer operation, and may operate as part of a server that has a joint function of storing account data, approving transaction requests, and setting authorization pads in near real time during the authorization of a transaction.

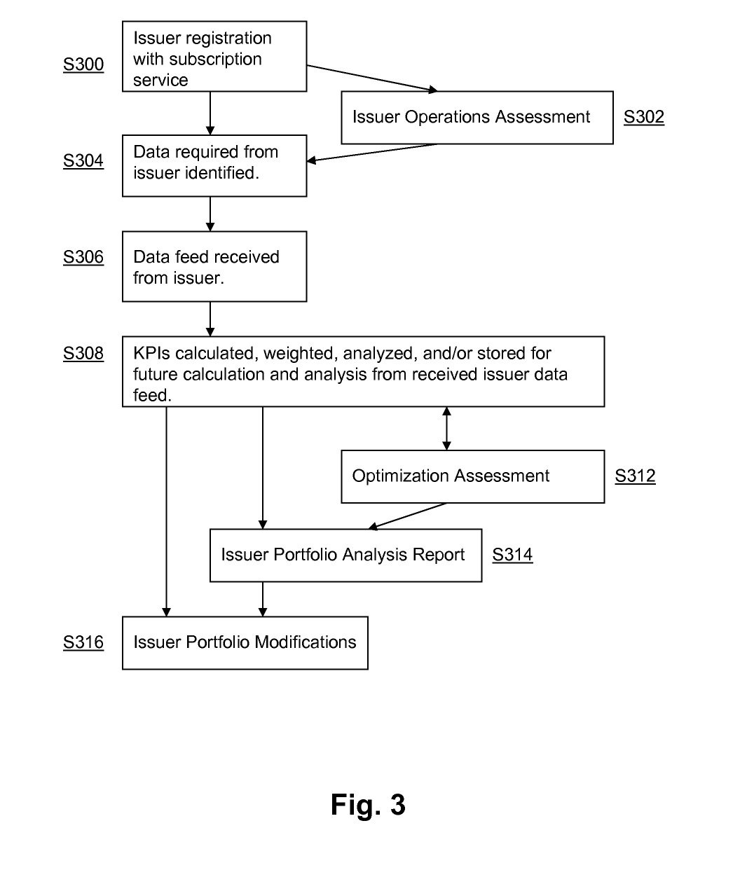

FIG. 3 then describes a method of providing NPSL analysis and management in an issuer registration embodiment described by the block diagram of FIG. 2. In step S300, an issuer registers with an NPSL subscription server. The service may include an optional step s302 that includes pre-launch operations assessments or portfolio reviews, and then in step s304, the data required from the issuer is identified. In s306, the issuer provides a regular data feed to the subscription service. The data feed may be continuous, or set at any period either in conjunction with analysis reports and portfolio modifications, or at any other identified interval sufficient to enable the reports and modifications.

In step s308, after the data feed is received by the subscription service, the KPIs for the portfolio are calculated. KPIs may further be weighted and analyzed to determine risk in conjunction with previous data for the specific portfolio or as part of a benchmarking comparison across multiple portfolios. For example, in one alternative embodiment, the subscription service functions as a clearinghouse with data from multiple issuers, where the specifics of the data are held private from issuers. Multiple data feeds may be received for different issuers at the subscription service, and KPIs stored for many portfolios and issuers. Metrics and risk for an individual issuer, portfolio, or portfolio segment may then be created based not only on current and historical data for the specific issuer portfolio segment, but based on a much broader set of data which matches the identified portfolio segment being analyzed for a specific issuer.

At various points either within an analysis described as step S308, after, or as part of a feedback with step S308, step s312 may involve an optimization assessment. This may involve issuer input related to goals and trends that lead to KPI weighting and additional analysis as described for step s308.

After the analysis of a data feed is complete, an analysis report is created in step s314, and/or specific modifications to an issuer portfolio are recommended, sent to an issuer, or automatically placed into effect. These modifications are the directly adjustable portfolio characteristics discussed elsewhere in this disclosure, including characteristics such as interest rates or account revolve and pad limits.

### III. Network Based NPSL Analysis

As described above, NPSL analysis in accordance with the innovations presented herein may be implemented as part of a subscription based service external to an account issuer, or may be implemented internally as part of the operations of an individual issuer. Additionally, NPSL may be implemented or integrated into a payment process by which transactions are approved in a network. Such embodiments may function with either a subscription based service, an internal issuer service, or any other service model internal or external to the operations of an issuer with a portfolio being analyzed.

Significant amounts of issuer data consist of credit card transaction data, and for some portfolios, may consist entirely of transactions occurring in a single payment processing network such as VisaNet™. Network based implementations of NPSL analysis which is integrated with the payment processing network therefore may be implemented with an advantage of automatic receipt, close ties, and fast creation of data for use in NPSL analysis.

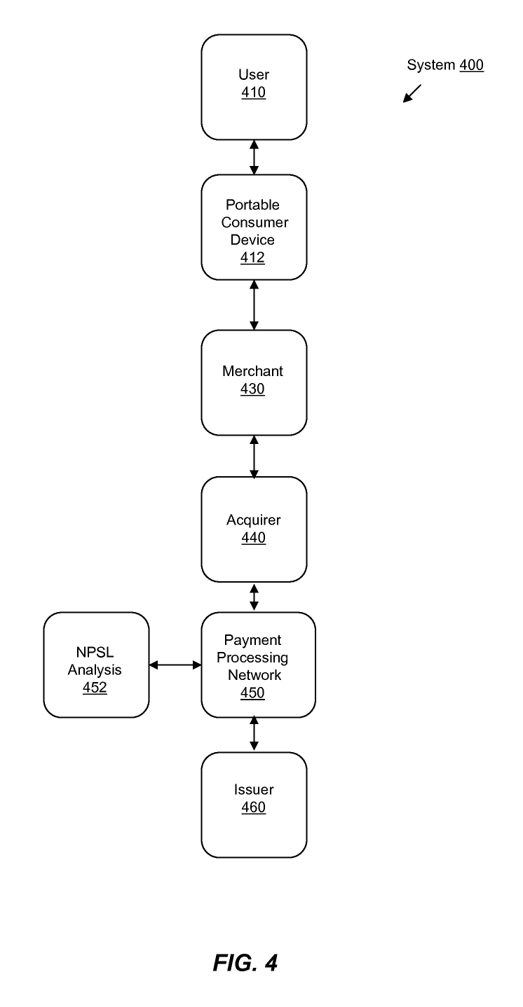

FIG. 4 describes one potential embodiment of a system 400 for a transaction. During a payment transaction, user 410 purchases goods or services using portable consumer device 412 issued to user 410 by issuer 460. Portable consumer device 412 may be associated with an account having NPSL features, or may be grouped by issuer 460 as part of a portfolio where other accounts have NPSL features. The user 410 takes his portable consumer device 412 and passes it by a reader in an access device at the merchant 430. Alternatively, user 410 may input a card number with a card verification value (CVV) and transmit the number to the merchant 430 via a network. The merchant 430 access device then generates an authorization request message, which is sent to the payment processing network 450 via the acquirer 440. The authorization request message can contain information such as the amount of the purchase as well as a merchant identifier indicating the identity of the merchant.

Transaction and authorization messages may include data which may be directly compiled into portions of the data of table 1 shown above. In certain embodiments, the data received from transaction messages in a network may need to be supplemented with additional data from an issuer.

In the embodiment shown in FIG. 4, the payment processing network 450 retrieves data and conveys the data to NPSL analysis 452. NPSL analysis 452 may be part of a server or server network within payment processing network 450, or may be an independent server operating as an independent analysis server or as part of another server network.

In alternative embodiments, NPSL analysis 452 may be disposed within issuer 460, acquirer 440, or merchant 430. In these alternative embodiments, the sets of data collected are likely to be different, focusing on the data that passes through the devices of the entity performing the NPSL analysis. For example, in one potential embodiment, the merchant 430 may also function as an issuer 460 with accounts only usable for making purchases from the merchant 430. In such a circumstance, transaction data and any other necessary user data is likely to be readily available to the merchant/issuer, but the analysis will not be able to include broader sets of data from other issuers.

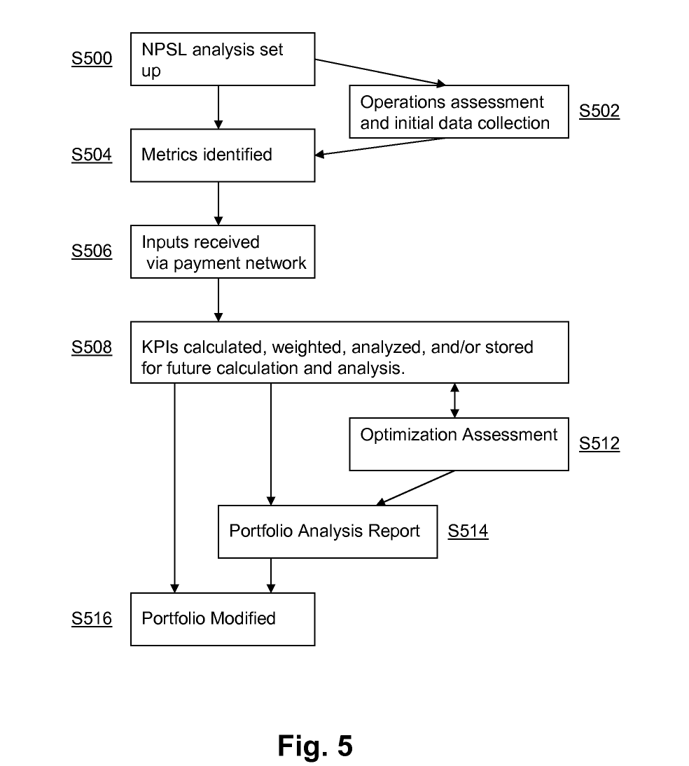

In FIG. 5, the method associated with the network of FIG. 4 is described. In step s500, the initial NPSL analysis is structured and organized. Required data unlikely to be retrieved through the network may be collected in step s502, such as credit scores, location data, or other initial historical data. The portfolio is likely to be identified at this point, so that data for individual accounts may be associated with a portfolio. In step s506, the data is received in a stream from individual transactions, and collected into data for a portfolio, and in step s508-516, the data collected from network transactions and other sources is analyzed and used to create reports and portfolio modifications.

For any of the above described embodiments, or any embodiment described herein, metrics and key performance indexes may use different alternative methods for signaling changes in NPSL account characteristics. By electronically analyzing data, a server computer may perform decision analysis for NPSL account management. For example, a server computer performing NPSL analysis may have threshold targets for single or groups of metrics and/or indexes. Alternatively, complex formulas to set thresholds based on an influence of multiple metrics and/or indexes may set windows or thresholds for altering one or more characteristics of an NPSL account. Such windows or thresholds may be based on average, standard deviation, or other statistical values associated with NPSL data and data variation for a group of NSPL account holders. Further still, rather than directly managing an NPSL account, such thresholds may electronically trigger a communication to an account holder disclosing an upcoming adjustment to NPSL account characteristics in accordance with policy or legal requirements prior to any actual adjustment to the account characteristics.

Additionally, for any of the above described embodiments, or any embodiment described herein, the accounts being analyzed may comprise both NPSL accounts and non-NPSL accounts. Non-NPSL accounts are accounts with a preset spending limit, or accounts with no pad amount that may be spent in a given period with no penalty. In certain embodiments, non-NPSL accounts may be analyzed to determine if they may be targeted for conversion to NPSL accounts. Thus, in certain embodiments, a characteristic of an account may be an NPSL status, or an authorization pad that is zero for non-N PSL accounts and greater than zero for NPSL accounts. The same types of threshold and risk analysis discussed elsewhere may be used, including metrics and key performance indicators, to analyze non-NPSL accounts using electronic NPSL analysis in order to add or offer a NPSL feature to the account.

### IV. Alternative Embodiments

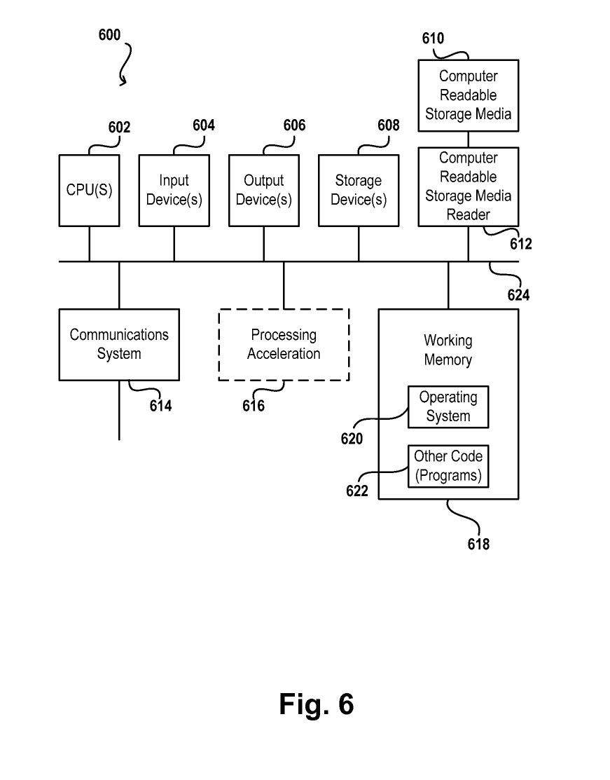

FIG. 6. illustrates an exemplary computer system 600, which may also be considered a server computer, in which various embodiments may be implemented. The system 600 may be used to implement any of the computer systems described above (e.g., client computer, a server computer at the payment processing network, a computer apparatus at the merchant, etc.). The computer system 600 is shown comprising hardware elements that may be electrically coupled via a bus 624. The hardware elements may include one or more central processing units (CPUs) 602, one or more input devices 604 (e.g., a mouse, a keyboard, etc.), and one or more output devices 606 (e.g., a display device, a printer, etc.). The computer system 600 may also include one or more storage devices 608. By way of example, the storage device(s) 608 can include devices such as disk drives, optical storage devices, solid-state storage device such as a random access memory (“RAM”) and/or a read-only memory (“ROM”), which can be programmable, flash-updateable and/or the like.

The computer system 600 may additionally include a computer-readable storage media reader 612, a communications system 614 (e.g., a modem, a network card (wireless or wired), an infra-red communication device, etc.) that may be used to implement a communication link for receiving and communicating NPSL data. A communication link may also be established by memory that is physically transported and connected to computer system 600, such as a USB memory hard drive that is connected to computer system 600. Computer system 600 may also include working memory 618, which may include RAM and ROM devices as described above. In some embodiments, the computer system 600 may also include a processing acceleration unit 616, which can include a digital signal processor DSP, a special-purpose processor, and/or the like.

The computer-readable storage media reader 612 can further be connected to a computer-readable storage medium 610, together (and, optionally, in combination with storage device(s) 608) comprehensively representing remote, local, fixed, and/or removable storage devices plus storage media for temporarily and/or more permanently containing, storing, transmitting, and retrieving computer-readable information. Thus a communication link may be established to computer system 600 using multiple methods, such as electrical or optical communication cables, or mobile computer readable storage media. The communications system 614 may permit data to be exchanged with the network and/or any other computer described above with respect to the system 600.

The computer system 600 may also comprise software elements, shown as being currently located within a working memory 618, including an operating system 620 and/or other code 622, such as an application program (which may be a client application, Web browser, mid-tier application, RDBMS, etc.). It should be appreciated that alternate embodiments of a computer system 600 may have numerous variations from that described above. For example, customized hardware might also be used and/or particular elements might be implemented in hardware, software (including portable software, such as applets), or both. Further, connection to other computing devices such as network input/output devices may be employed.

FIG. 7 describes a further embodiment of a method of performing NPSL analysis identifying the process as an ongoing loop of continuous recording of data, review of metrics, and adjustment of portfolio characteristics. In step s700, the initial state of the portfolio characteristics is set. In step s702, transaction data is recorded or input in the analysis system as described in the embodiments detailed above. As part of a ongoing continuous NPSL analysis, the number and identity of accounts within a portfolio may not be static. Accounts may be closed and new accounts added within portfolios, but the same analysis may be maintained with previous information for a portfolio continuing to provide effective analysis for the entire portfolio even as accounts within the portfolio change. In step s704, portfolio segments are identified, and accounts are distributed among the segments. If metrics for an individual account have changed, an account may be moved from one portfolio segment to another portfolio segment. Metrics are calculated from the input data in step s706. This step may further attempt to correlate previous adjustments to portfolio characteristics with the resulting changes to portfolio metrics. New and updated portfolio metrics are then calculated in step s708, and in step s710 adjustments to the portfolio characteristics are made.

Following update of the portfolio characteristics in step s710, assuming the NPSL analysis is not being terminated, the system will enter a continuous loop where information may be derived for cause and effect relationships between various characteristics and parameters, and the relationships used to improve and impact the reports and future adjustments of portfolio characteristics.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

One or more features from any embodiment may be combined with one or more features of any other embodiment without departing from the scope of the invention.

A recitation of “a”, “an” or “the” is intended to mean “one or more” unless specifically indicated to the contrary.

What is claimed is:

1. A method of setting a characteristic for an NPSL (no pre-set spending limit) account comprising:
electronically receiving a set of data for a plurality of NPSL accounts at a server computer via a communication link;
identifying, using the server computer, at least one performance metric for each account in the plurality of accounts;
identifying, using the server computer, a use status for each account of the plurality of accounts as a transactor, a revolver, or an inactive status;
electronically grouping the plurality of NPSL accounts by the at least one performance metric and the use status of each account to create a plurality of account groups and electronically analyzing each group of the plurality of account groups using the server computer; and
adjusting, using the server computer, the characteristic for the NPSL account by electronically adjusting the characteristic for each account in a first group of the plurality of account groups by an amount determined by the analyzing of each group of the plurality of account groups.

2. The method of claim 1 wherein electronically analyzing each group of the plurality of groups comprises electronically determining a key performance index for each of the account groups using the server computer.

3. The method of claim 2 wherein adjusting, using the server computer, the characteristic for the NPSL account further comprises electronically determining a risk associated with the NPSL account using the key performance index;
electronically determining a change in risk associated with a change in the characteristic; and
adjusting the characteristic based on the electronically determined change in risk.

4. The method of claim 1 wherein the performance metric comprises a cycle balance total for the account.

5. The method of claim 1 wherein the characteristic for the NPSL account is an authorization pad amount.

6. The method of claim 1 wherein the characteristic for the NPSL account is an interest rate for the NPSL account.

7. The method of claim 1 wherein the set of data is a data feed received at the server computer from an issuer.

8. The method of claim 1 wherein the performance metric comprises an expected loss rate.

9. The method of claim 1 further comprising:
receiving, at the server computer, a set of baseline data for the plurality of NPSL account prior to the receiving of the set of data;
electronically analyzing the set of baseline data to determine data required for no pre-set spending limit analysis; and
communicating, from the server computer to an issuer, a request for the set of data for the plurality of NPSL accounts.

10. The method of claim 1 further comprising:
receiving a second set of data at the server computer;
electronically analyzing the second set of data to identify additional accounts not associated with the plurality of NPSL accounts;
electronically grouping the additional accounts with the plurality of NPSL accounts by the at least one performance metric and the use status of the additional accounts to incorporate the additional accounts into the plurality of account groups;
and electronically analyzing each group of the plurality of account groups including the additional accounts using the server computer.

11. A server computer comprising:
a processor;
an interface for a communication link; and
an data storage device communicatively coupled to the processor and the interface, the data storage device storing therein instructions readable by the processor for performing a method of setting and managing a characteristic of an NPSL account;
wherein the method of setting and managing the characteristic of the NPSL account comprises:
electronically receiving a set of data for a plurality of NPSL accounts at the server computer via the communication link;
identifying, using the processor, at least one performance metric for each account in the plurality of accounts;
identifying, using the processor, a use status for each account of the plurality of accounts as a transactor, a revolver, or an inactive status;
electronically grouping the plurality of NPSL accounts by the at least one performance metric and the use status of each account to create a plurality of account groups and electronically analyzing each group of the plurality of account groups using the processor.

12. The server of claim 11 with the method further comprising adjusting, using the processor, the characteristic for the NPSL account by electronically adjusting the characteristic for each account in a first group of the plurality of account groups by an amount determined by the analyzing of each group of the plurality of account groups.

13. The server of claim 11 wherein electronically analyzing each group of the plurality of groups comprises electronically determining a key performance index for each of the account groups using the server computer.

14. The server of claim 13 with the method further comprising:
electronically determining a risk associated with the NPSL account using the key performance index;
electronically determining a change in risk associated with a change in the characteristic.

15. The server of claim 11 with the method further comprising communicating, to an issuer computer associated with the NPSL account, the risk and the change in risk.

16. The server of claim 11 wherein the performance metric comprises an issuer internal risk score.

17. The server of claim 14 wherein the key performance index comprises an average charge off rate.

18. A method of setting a characteristic for an account comprising:
receiving, at a server computer, a set of data for a plurality accounts comprising NPSL accounts and non-NPSL accounts;
identifying a performance metric for each account in the plurality of accounts;
identifying a use status for each account of the plurality of accounts as a transactor, a revolver, or an inactive status;
grouping the plurality accounts by the performance metric and the use status of each account to create a plurality of account groups;
analyzing each group of the plurality of account groups; and
adjusting the characteristic for the account by adjusting the characteristic for each account in a first group of the plurality of account groups by an amount determined by the analyzing of each group of the plurality of account groups.

19. The method of claim 18 wherein the account characteristic is an authorization pad; and
wherein the authorization pad is zero for the non-NPSL accounts.

20. The method in accordance with claim 18, wherein the analysis of the data further comprises of:
using active account management to segment the portfolio by internal behavior score bands;
overlaying key performance metrics;
assessing authorization pad structure; and
identifying areas of risks and opportunities.
